(19) United States
(12) Patent Application Publication
(10) Pub. No.: US 2023/0419315 A1
(43) Pub. Date: Dec. 28, 2023

(54) DATA PROVISIONING FRAMEWORK USING NON-FUNGIBLE TOKENS

(71) Applicant: SONY GROUP CORPORATION, TOKYO (JP)

(72) Inventors: TAKASHI TOGAME, BANGALORE (IN); SADAYOSHI MURAO, BANGALORE (IN); SRINIVASA PINGILI, BANGALORE (IN)

(21) Appl. No.: 18/188,172

(22) Filed: Mar. 22, 2023

Related U.S. Application Data
(60) Provisional application No. 63/366,781, filed on Jun. 22, 2022.

(51) Int. Cl. G06Q 20/38; G06Q 20/40

(52) U.S. Cl. CPC G06Q 20/389; G06Q 20/3825; G06Q 20/401

(57) ABSTRACT

A system and method for data provisioning using non-fungible tokens (NFTs) is disclosed. The system stores a dataset associated with a data owner and receives a purchase request from an account of a data user for an NFT that represents the dataset on a ledger. The system updates ownership information of the NFT to include the data user based on whether the purchase request satisfies terms associated with a sale of the NFT. The system receives an access request for the dataset and validates the request based on the ownership information and whether the access request satisfies access rules for the dataset and terms associated with usage of the dataset. The system serves a copy of the dataset to an analytics system based on the validation and determines a consumption pattern of the copy. The system controls access to the copy on the analytics system based on the consumption pattern.

### CROSS-REFERENCE TO RELATED APPLICATIONS/INCORPORATION BY REFERENCE

This application claims priority to U.S. Provisional Patent Application Ser. No. 63/366,781 filed on Jun. 22, 2022, the entire content of which is hereby incorporated herein by reference.

### FIELD

Various embodiments of the disclosure relate to non-fungible tokens. More specifically, various embodiments of the disclosure relate to an electronic device and method for data provisioning framework using non-fungible tokens.

### BACKGROUND

Advancements in information technology have led to development of tools that allow different service providers to collaborate and offer services to users via a single software application. For example, a number of mobility service providers may register on a Mobility-as-a-Service network to offer multimodal transport services to the users via a MaaS application. Based on the services, the software application may accumulate a large set of data on each user over a period of time. The data may be useful for applications, such as fleet operations for a geographical area or a demand estimation for services offered by the mobility service providers. Depending on a significance or a size of the data, a data owner may want to sell or share the data with users under certain terms and conditions. On traditional IT systems that follow a client-server model, it may be difficult to identify customers who may purchase the data with malicious intentions to misuse, tamper, or resell the data for profit. It may be further difficult for a traditional IT system to prevent such misuse or any attempt to tamper or resell the data.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for data provisioning framework using non-fungible tokens is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary system for data provisioning using non-fungible tokens, in accordance with an embodiment of the disclosure.

FIG. 2 is a block diagram that illustrates an exemplary Mobility-as-a-Service (MaaS) transportation network of FIG. 1, in accordance with an embodiment of the disclosure.

FIGS. 3A and 3B collectively illustrate an exemplary sequence of operations for data provisioning using non-fungible tokens for data provisioning using non-fungible tokens, in accordance with an embodiment of the disclosure.

FIGS. 4A and 4B are diagrams that collectively illustrate an exemplary scenario for data provisioning using non-fungible tokens, in accordance with an embodiment of the disclosure.

FIG. 5 is a block diagram that illustrates an exemplary data collection system, in accordance with an embodiment of the disclosure.

FIG. 6 is a flowchart that illustrates operations of an exemplary method for data provisioning using non-fungible tokens, in accordance with an embodiment of the disclosure.

### DETAILED DESCRIPTION

The following described implementation may be found in the system and method for data provisioning using non-fungible tokens. The system covers end-to-end process of digital supply chain process, such as dataset creation or definition (original data), sale, ownership of dataset, consumption of dataset for analytics purpose, and the like. Exemplary aspects of the disclosure may provide a system that may execute operations for data provisioning using non-fungible tokens. The system may store a dataset associated with a data owner in a storage device. At any time-instant, the system may receive a purchase request for a non-fungible token (NFT) from one or more accounts of data users. The NFT may represent the dataset on a distributed ledger. The system may update ownership information of the NFT on the distributed ledger to include the data user based on whether the purchase request satisfies terms associated with a sale of the NFT. Thereafter, the system may receive an access request for the dataset. The access request may be validated based on the ownership information and whether the access request satisfies at least one of access rules for the dataset and terms associated with a usage of the dataset. The system may serve a copy of the dataset from the storage device to an analytics system associated with the data user based on the validation. After the copy is served, the system may determine a consumption pattern of the served copy on the analytics system and may control an access to the copy of the dataset on the analytics system based on the consumption pattern.

Applications that connect different mobility providers may generate volumes of datasets. Such datasets may be owned by data owners. For example, a user of an application that offers MaaS using one or more modes of public or private transport may be a data owner of a dataset of MaaS trips. For example, the dataset may contain information about usage of types of a transport ticket, such as a one-time use ticket, a subscription-based ticket, a seasonal ticket, and the like. If the dataset is valuable, the data owner may want to share or sell the dataset to a trusted party. On conventional IT systems, it might be challenging to detect customers who may buy the dataset with the intent to use dataset maliciously, tamper with the dataset, or resell the dataset for a profit. A conventional IT system might have much more trouble stopping such misuse or any attempt to alter with or sell the dataset. Thus, there is a need for a data provisioning framework that may ensure a secure and tamper-proof access to such datasets.

In order to address the issues and fulfil the need, the present disclosure introduces the system that provides data provisioning using non-fungible tokens. The disclosed system may leverage a distributed ledger to protect ownership and access permissions of the datasets. Once such datasets are created on the distributed ledger, open technologies to may be used share encrypted version of the dataset and to prevent illegal copying of the dataset. For example, the disclosed system may create the NFT on a public distributed ledger based on whether the dataset satisfies conditions for a creation of NFT. The created NFT may be listed on a NFT marketplace associated with the public distributed ledger. The system may receive the purchase request the NFT from an account of a data user. For example, the purchase request may be received based on a selection of the listed NFT on the NFT marketplace. The system may determine whether the purchase request satisfies terms associated with the sale of the NFT. The data user may then make a payment for the purchase of NFT. Once the NFT is purchased, the system may update the ownership information of the NFT on the distributed ledger to include the data user.

The system may receive the access request for the dataset via a user device and may validate the access request based on the ownership information and further based on whether the access request satisfies at least one of access rules for the dataset and terms associated with the usage of the dataset. The system may serve the copy of the dataset from the storage device to the analytics system upon validation and may determine the consumption pattern of the dataset. The access to the copy of the dataset on the analytics system may be controlled based on the consumption pattern. Thus, the system provides the data provisioning framework to securely share the dataset such as travel data to limited participants who have the ownership of the NFT for the dataset. The system may further protect rights on the usage of the dataset may prevent illegal copying of the datasets.

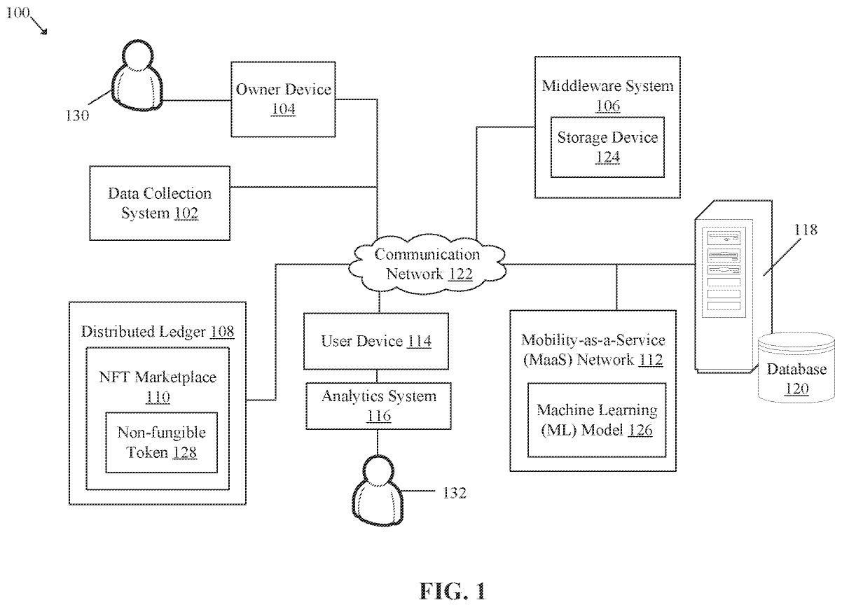

FIG. 1 is a block diagram that illustrates an exemplary system for data provisioning using non-fungible tokens, in accordance with an embodiment of the disclosure. With reference to FIG. 1, there is shown a diagram of a system 100. The system 100 may include a data collection system 102, an owner device 104, a middleware system 106, a distributed ledger 108, a non-fungible token (NFT) marketplace 110, a mobility-as-a-service (MaaS) network 112, a user device 114, an analytics system 116, a server 118, a database 120, and a communication network 122. The middleware system 106 may include a storage device 124. The MaaS network 112 may include a machine learning (ML) model 126. The distributed ledger 108 may be used to store NFTs for purchase on the NFT marketplace 110. As an example, the NFT marketplace 110 may list an NFT 128 for a dataset. The data collection system 102, the owner device 104, the middleware system 106, the distributed ledger 108, the MaaS network 112, the user device 114, the analytics system 116, and the server 118 may be communicatively coupled to one another, via the communication network 122. In FIG. 1, there is further shown a data owner 130 who may be associated with the owner device 104 and a data user 132 who may be associated with the user device 114. The data owner 130 may be a first owner of the dataset.

The system 100 may include suitable logic, circuitry, and interfaces that may be configured to provide a secure mechanism of data provisioning for datasets associated with various data owners. The system 100 may enable data owners (such as the data owner 130) to submit the datasets and request for creation of NFTs (such as the NFT 128) on the distributed ledger 108. After the creation, such NFTs may be listed on the NFT marketplace 110 and data users (such as the data user 132) may purchase the NFTs (such as the NFT 128) to gain access to the respective datasets represented by such NFTs. The system 100 may also enable a secure storage of the datasets by use of a suitable encryption technique (e.g., an asymmetric encryption technique that uses public and private keys to encrypt the datasets). Examples of the system 100 may include, but are not limited to, a network of Internet of Things (IoT) devices, a group of mainframe machines, a centralized server or a datacenter with multiple shared resources, a network of computer workstations, a network of edge devices, or a combination thereof.

The data collection system 102 may include suitable logic, circuitry, and interfaces that may be configured to receive the dataset from the data owner 130 and create the NFT 128 on the distributed ledger 108 based on whether a dataset (i.e., data submitted by the data owner 130) satisfies conditions for a creation of the NFT 128. The data collection system 102 may receive a purchase request for the NFT 128 from an account of the data user 132. The account may be, for example, a wallet account of the data user 132 on the distributed ledger 108 or a distributed ledger other than the distributed ledger 108. In an example, the account may be associated with a decentralized application (DApp) that may be linked to the distributed ledger 108. The DApp may include functions to search, list, and buy NFTs. Access to the DApp may be authenticated based on the account associated with the DApp, a decentralized identifier, and the like. The data collection system 102 may update ownership information of the NFT 128 on the distributed ledger 108 to include the data user 132 based on whether the purchase request satisfies terms associated with a sale of the NFT 128. Examples of the data collection system 102 may include, but are not limited to, a network of Internet of Things (IoT) devices, a group of mainframe machines, a centralized server, a datacenter with multiple shared resources, a network of computer workstations, or a network of edge devices.

The owner device 104 may include suitable logic, circuitry, and interfaces that may be configured to transmit a request for onboarding of the data owner 130 onto the data collection system 102. The owner device 104 may be associated with the data owner 130. Examples of the owner device 104 may include, but are not limited to, a computing device, a hardware-based annealer device, a smartphone, a cellular phone, a mobile phone, a gaming device, a mainframe machine, a server, a computer workstation, and/or a consumer electronic (CE) device.

The middleware system 106 may include a software application that may act as bridge between the storage device 124 and applications running on the data collection system 102. The middleware system 106 may be responsible for management and distribution of data stored on the storage device 124.

The distributed ledger 108 may be a decentralized and distributed database system that may maintain an immutable record of data operations or transactions. A set of data operations may be grouped together as a block and may be further linked to a previous block of data operations to form a chain of a plurality of blocks. All blocks of data operations may be stored in a decentralized manner, whereby all participants or nodes store all the plurality of blocks. Further, the distributed ledger 108 may include an operating system which may allow for deployment of a set of smart contracts between multiple parties.

The distributed ledger 108 may maintain a chain of blocks which may use accounts as state objects and a state of each account may be tracked by the chain. The accounts may represent identities of users, mining nodes, or automated agents. All the blocks of data operations or the smart contracts may be associated with accounts on the chain of blocks. By way of example, and not limitation, the distributed ledger 108 may be a Blockchain ledger which may use accounts as state objects and a state of each account may be tracked by the blockchain. The scope of the disclosure may not be limited to the implementation of the distributed ledger 108 as a particular type of ledger. Other implementations of the distributed ledger 108 may be possible in the present disclosure, without a deviation from the scope of the present disclosure.

The NFT marketplace 110 may be an application such as a digital marketplace that may be used for listing NFTs for sale. For example, the NFT 128 may be listed on the NFT marketplace 110. The NFT marketplace 110 may include a front-end interface that may be accessible via a web client and a back-end interface that may be linked to the distributed ledger 108. For example, the front-end interface may be a User Interface (UI) of a web application, a website, or a mobile application. The data collection system 102 may receive a purchase request for the NFT based on a user input associated with the selection of the NFT 128 via the NFT marketplace 110.

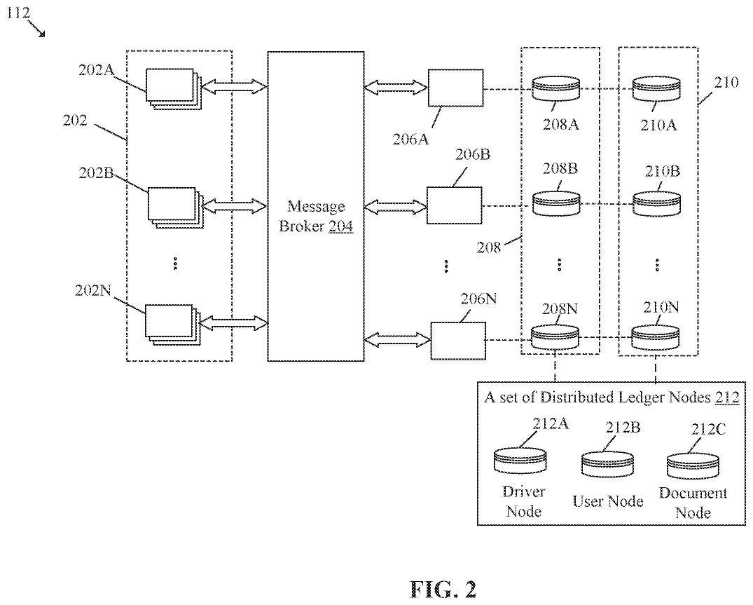

The MaaS network 112 may be an application that may enable a user to plan a trip which involves services of different transport providers. The MaaS network 112 may include a message broker, a set of publisher nodes, a set of distributed ledger nodes, and a set of subscriber nodes that communicates with the set of publisher nodes via the message broker. The set of publisher nodes may be communicatively coupled to the distributed ledger 108. The MaaS network 112 may facilitate multiple homogeneous or heterogenous mobility providers and their infrastructure, such as ticketing gates, applications, and/or Point of Sale (PoS) devices to operate on the MaaS network 112 to provide various mobility services. Each mobility provider may enjoy secure data ownership and may co-use relevant transaction data through at least one node of the set of distributed ledger nodes. This may enhance connectivity between various mobility providers. Details related to the MaaS network 112 are further provided, for example, in FIG. 2.

The user device 114 may include suitable logic, circuitry, and interfaces that may be configured to provide a purchase request for the NFT 128 that represents the dataset on the distributed ledger 108 based on a user input. Further, the user device 114 may provide an access request for the dataset to the data collection system 102. The user device 114 may be associated with the data user 132. Examples of the user device 114 may include, but are not limited to, a computing device, a hardware-based annealer device, a digital-annealer device, a quantum-based or quantum-inspired annealer device, a smartphone, a cellular phone, a mobile phone, a gaming device, a mainframe machine, a server, a computer workstation, and/or a consumer electronic (CE) device.

The analytics system 116 may include suitable logic, circuitry, and interfaces that may be configured to receive a copy of the dataset from the storage device 124 upon authentication of an access request from the data user 132. The analytics system 116 may include software tools to process and analyze the received copy of the dataset. In some embodiments, the functionalities of the analytics system 116 may be incorporated at least partially or in its entirety in the user device 114 associated with the data user 132. Examples of the analytics system 116 may include, but are not limited to, a computing device, a smartphone, a cellular phone, a mobile phone, a gaming device, a mainframe machine, a server, a computer workstation, and/or a consumer electronic (CE) device.

The server 118 may include suitable logic, circuitry, and interfaces, and/or code that may be configured to control an access to the copy of the dataset on the analytics system 116 based on a consumption pattern. The server 118 may be implemented as a cloud server and may execute operations through web applications, cloud applications, HTTP requests, repository operations, file transfer, and the like. Other example implementations of the server 118 may include, but are not limited to, a database server, a file server, a web server, a media server, an application server, a mainframe server, or a cloud computing server.

In at least one embodiment, the server 118 may be implemented as a plurality of distributed cloud-based resources by use of several technologies that are well known to those ordinarily skilled in the art. A person with ordinary skill in the art will understand that the scope of the disclosure may not be limited to the implementation of the server 118 and the data collection system 102, as two separate entities. In certain embodiments, the functionalities of the server 118 can be incorporated in its entirety or at least partially in the data collection system 102, without a departure from the scope of the disclosure. In certain embodiments, the server 118 may host the database 120. Alternatively, the server 118 may be separate from the database 120 and may be communicatively coupled to a device that stores the database 120.

The database 120 may be configured to store the copy of dataset. The database 120 may be stored or cached on a device, such as a server (e.g., the server 118) or the data collection system 102. In some embodiments, the database 120 may be hosted on a plurality of servers stored at same or different locations. The operations of the database 120 may be executed using hardware, including a processor, a microprocessor (e.g., to perform or control performance of one or more operations), a field-programmable gate array (FPGA), or an application-specific integrated circuit (ASIC).

The communication network 122 may include a communication medium through which the data collection system 102, the owner device 104, the middleware system 106, the distributed ledger 108, the NFT marketplace 110, the MaaS network 112, the user device 114, the analytics system 116, and the server 118 may communicate with one another. The communication network 122 may be one of a wired connection or a wireless connection. Examples of the communication network 122 may include, but are not limited to, the Internet, a cloud network, Cellular or Wireless Mobile Network (such as Long-Term Evolution and 5^{th} Generation (5G) New Radio (NR)), a Wireless Fidelity (Wi-Fi) network, a Personal Area Network (PAN), a Local Area Network (LAN), or a Metropolitan Area Network (MAN). Various devices in the system 100 may be configured to connect to the communication network 122 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The storage device 124 may include suitable logic, interfaces, and/or code that may be configured to store the dataset. The storage device 124 may be included in or integrated into a device, such as a server (e.g., the server 118) or the data collection system 102. The operations of the storage device 124 may be executed using hardware, including a processor, a microprocessor (e.g., to perform or control performance of one or more operations), a field-programmable gate array (FPGA), or an application-specific integrated circuit (ASIC). In some other instances, the database 120 may be implemented using software.

The ML model 126 may be a classifier model which may be trained to identify a relationship between inputs, such as features in a training dataset and output labels. The ML model 126 may be defined by its hyper-parameters, for example, a number of weights, a cost function, an input size, a number of layers, and the like. The parameters of the ML model 126 may be tuned and weights may be updated so as to move towards a global minimum of a cost function for the ML model 126. After several epochs of the training on the feature information in the training dataset, the ML model 126 may be trained to output a classification result for a set of inputs. The classification result may be indicative of a class label for each input of the set of inputs (e.g., input features extracted from new/unseen instances). For example, if the violation of the terms associated with the sale of the NFT, the access rules for the dataset, or the terms associated with the usage of the dataset is detected based on the consumption pattern, then the ML model 126 may classify the data user 132 with a blacklist label.

The ML model 126 may include electronic data, which may be implemented as, for example, a software component of an application executable on the data collection system 102. The ML model 126 may rely on libraries, external scripts, or other logic/instructions for execution by a processing device. The ML model 126 may rely on computer-executable codes and routines to enable a computing system such as the MaaS network 112 to perform one or more operations such as a determination of whether there in violation of the terms associated with the sale of the NFT 128. Additionally, or alternatively, the ML model 126 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 126 may be implemented using a combination of hardware and software.

NFTs may be described as a type of digital assets that represent ownership or proof of authenticity of a unique item or object. For example, the NFT 128 may represent ownership or proof of authenticity of a dataset associated with the data owner 130. NFTs may be typically stored on a distributed ledger (such as the distributed ledger 108) and are not interchangeable, meaning that the NFTs are unique and have distinct values. In general, NFTs cannot be copied, substituted, or subdivided on the distributed ledger. This is in contrast to traditional cryptocurrencies which may be seen as interchangeable with a uniform value.

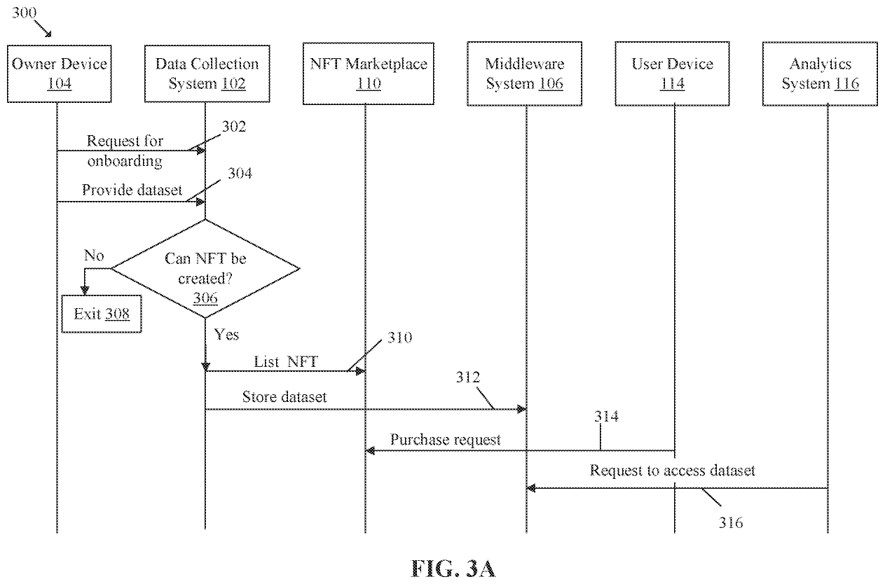

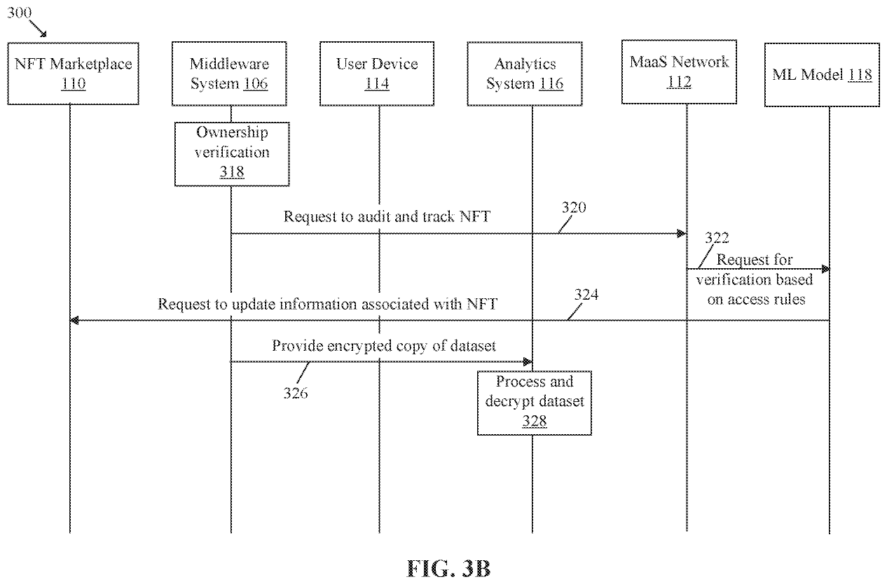

In operation, the data collection system 102 may control the middleware system 106 to store dataset associated with the data owner 130 on the storage device 124. In an embodiment, a raw version of the dataset may be stored on the storage device 124. In another embodiment, the dataset may be encrypted, and the encrypted dataset may be stored on the storage device 124. Details related to the storage of the dataset are provided, for example, in FIG. 3A.

At any time-instant, the NFT marketplace 110 may receive a purchase request for the NFT 128 from an account of the data user 132. The account may be a wallet, or an account associated with the DApp that may be linked with the distributed ledger 108. The NFT 128 may represent the dataset on the distributed ledger 108. The NFT marketplace 110 may be a digital marketplace where the NFT 128 may be listed for purchase. The NFT marketplace 110 may receive the purchase request based on a user input provided by the data user 132. For example, the user input may be received based on user's interaction with a user interface (UI) element associated with the NFT 128. Details related to the purchase request are provided, for example, in FIG. 3A.

Once the purchase request is received, the data collection system 102 may update ownership information of the NFT 128 on the distributed ledger 108 to include the data user 132 based on whether the purchase request satisfies terms associated with a sale of the NFT 128. For example, the data collection system 102 may verify whether details specified in the purchase request satisfies terms associated with the sale of the NFT 128. In case the purchase request satisfies the terms associated with the sale of the NFT 128, then the ownership information of the NFT 128 may be updated to include the data user 132. Details related to the terms associated with the sale of the NFT 128 are provided, for example, in FIG. 3B.

The middleware system 106 may receive an access request for the dataset from the analytics system 116. Merely purchasing the NFT 128 may not allow the analytics system 116 associated with the data user 132 to access the dataset. The access request may be generated by the analytics system 116 based on a user input. The data collection system 102 may control the middleware system 106 to validate the access request based on the ownership information and whether the access request satisfies at least one of access rules for the dataset and terms associated with a usage of the dataset. For example, once the access request is received, the ownership information may be verified to determine whether the account from which the access request is received is the same account of the data user 132 that was used to purchase the NFT 128. Once the ownership information is validated, information specified in the access request may be verified to determine whether the access request satisfies the access rules for the dataset and terms associated with the usage of the dataset. In case there is violation in the access rules for the dataset or the terms associated with the usage of the dataset, then the access request may be rejected. Details related to the validation of the access request are provided, for example, in FIG. 3B.

The data collection system 102 may control the middleware system 106 to serve a copy of the dataset from the storage device 124 to the analytics system 116 associated with the data user 132 based on the validation. For example, once the access request is validated, the middleware system 106 may stream the copy of the dataset to the analytics system 116. For example, the copy of the dataset may be streamed in an encrypted form and/or an anonymized form. The middleware system 106 may share private key(s) to decrypt the copy of the dataset separately with the wallet account of the data user 132. Details related to the serving of the copy of the dataset are provided, for example, in FIG. 3B.

After the copy of the dataset is served, the data collection system 102 may determine a consumption pattern of the served copy on the analytics system 116. The data collection system 102 may control the access to the copy of the dataset on the analytics system 116 based on the consumption pattern. For example, the data collection system 102 may analyze the consumption pattern to determine whether there is a violation of the terms associated with the sale of the NFT 128, the access rules for the dataset, or the terms associated with the usage of the dataset. In case the violation is detected, the data collection system 102 may prevent access to the copy of the dataset. Details related to the consumption pattern and the control of the access to the copy of the dataset are provided, for example, in FIG. 3B.

The disclosed system 100 may be advantageous to the data owner 130, an owner of the system 100, and the data user 132. The system 100 may provide higher profit margin to the data owner 130. Further, the disclosed system 100 may assist the data owner 130 in expanding a publishing business associated with the data owner 130 and in enhancing a primary and secondary market of the publishing business associated with the data owner 130. The system 100 may also provide a new opportunity for a newcomer and a market leader that want to sell the owned datasets. The data owner 130 may also market the dataset owned by the data owner 130 by auctioning the NFT 128 associated with the dataset. The disclosed system 100 may manage secondary market like analytics as a service and may prevent user's data from data spoofing and forgery. The data user 132 may be provided with option to directly communicate with the data owner 130. Further, the data user 132 may be assured that the dataset is genuine due to the involvement of the distributed ledger 108 and the MaaS network 112.

Usage of the data may be broadly classified as a primary and a secondary use. The primary use may be a transaction settlement between MaaS related players, such as Mobility provider and Mobility Service Provider for revenue sharing, and so on. Secondary use may include a re-use of dataset for analytics and so on, by Government, related institutes, service providers, such as location-based service (LBS) players, marketing companies, and the like. There may be other uses of processed data by data analytics players to re-sell as new NFT using the framework. For example, such data from the analytics may represent a new dataset that may be fit for creation of a new NFT for re-selling by analytics players using the same data provisioning framework. Usage patterns may indicate popular datasets that may be made eligible for further changes such as an option to provide additional benefit to owners by increasing price.

FIG. 2 is a block diagram that illustrates a MaaS network of FIG. 1, in accordance with an embodiment of the disclosure. FIG. 2 is explained in conjunction with elements from FIG. 1. With reference to FIG. 2, there is shown the MaaS network 112. The MaaS network 112 may be associated with a publish-subscribe pattern. The MaaS network 112 may include a set of publisher nodes 202A, 202B, . . . 202N, a message broker 204, and a set of subscriber nodes 206A, 206B . . . 206N. The MaaS network 112 may further include a plurality of mobility provider (MP) nodes 208A, 208B, . . . 208N of a first distributed ledger 208 and a plurality of MaaS nodes 210A, 210B . . . 210N of a second distributed ledger 210. Moreover, the MaaS network 112 may include a set of distributed ledger nodes 212 that may include a driver node 212A, a user node 212B, and a document node 212C.

The MaaS network 112 may support a standard specification for communication. The MaaS network 112 may include publisher nodes (e.g., ticket readers or ride booking applications), subscriber nodes, and at least one message broker to communicate transaction messages from the publishers nodes to the subscriber nodes, in accordance with a publish-subscribe network protocol, such as, but not limited to, a Message Queuing Telemetry Transport (MQTT)-based messaging protocol, an Advanced Message Queuing Protocol (AMQP)-based messaging protocol, or a Message-Oriented Middleware (MOM)-based messaging framework. In at least one embodiment, the MaaS network 112 may include a distributed ledger which may include ledger nodes to record transactions associated with various mobility services, such as ticketing transactions of a MaaS transportation service, media usage or consumption statistics, or settlement of payments among various stakeholders, such as content owners, transportation providers, or operators of the MaaS network 112.

The set of publisher nodes 202A, 202B, . . . 202N of all transportation service providers associated with the MaaS network 112 may follow a standard or common communication protocol for data exchange. The MaaS network 112 may include homogeneous publisher nodes that may follow the MaaS standard specification for communication. In an embodiment, the MaaS network 112 may also include heterogeneous publisher nodes that may follow proprietary communication protocols. The MaaS network 112 may offer a plugin-based support to the set of publisher nodes 202A, 202B, . . . 202N so that such heterogeneous publisher nodes can be supported until the respective transportation service providers adhere to and provide support for the MaaS standard specification for communication.

The MaaS network 112 may enable the publisher nodes associated with different transportation providers to join the MaaS network 112. Through a node management device, the MaaS network 112 may provide a bulk cluster management of the publisher nodes. All the publisher nodes may follow set protocols to operationalize on the MaaS network 112. The set protocols may mandate a common security architecture (for publisher node authentication and authorization), a network protocol (e.g., HTTP, MQTT, AMQP, and the like), a uniform data request or response format (e.g., JSON, CSV, or XML format), and an API/data scheme. This may ensure that each publisher node follows a cluster-level configuration (such as a device profile including a company name, a company ID, a gate ID, a gate number, and the like) and a device-level certificate (i.e., the authentication credential). The pattern of cluster-level configuration and the set protocols may facilitate transport providers to deploy new publisher nodes or replace existing publisher nodes with a plug-and-play approach. This may facilitate the MaaS network 112 to function as a homogeneous transportation network with interoperability between resources (such as publisher node devices) of the various transportation providers.

Each of the set of publisher nodes 202A, 202B . . . 202N may include suitable logic, circuitry, code, and/or interfaces that may be configured to operate as a ticket processing client for a transportation service of a respective transportation service provider. For example, as a ticket processing client, each of the set of publisher nodes 202A, 202B . . . 202N may read, issue, recharge, or cancel tickets to create events associated with a respective transport service. Based on such events, transaction messages may be communicated to one or more subscriber nodes (such as the set of subscriber nodes 206A, 206B . . . 206N) of the MaaS network 112 through the message broker 204. Examples of the set of publisher nodes 202A, 202B . . . 202N may include, but are not limited to, a consumer electronic device with a trip planning or booking application, a ticket reader on a ticketing gate, a ticketing kiosk a Point-of-Sale (PoS) device, a mobile POS, a ticket vending machine, a smart door of a transport vehicle which may read a ticket to start or end a ride.

Each of the set of subscriber nodes 206A, 206B . . . 206N may include suitable logic, circuitry, code, and/or interfaces that may be configured to receive the transaction messages, through the message broker 204, from one or more of the set of publisher nodes 202A, 202B . . . 202N. Each transaction message may include a topic which may be subscribed by one or more subscriber nodes of the set of subscriber nodes 206A, 206B . . . 206N. Example implementations of a subscriber node may include, but are not limited to, a web server, an edge device, an edge node, a cloud server, a cluster node of cloud-based servers, a workstation, or any computing device with a fog computing capability.

A first publisher node 202A of the set of publisher node 202A, 202B . . . 202N and a first subscriber node 206A of the set of subscriber nodes 206A, 206B . . . 206N may be associated with a first transportation provider. Other nodes, such as a second publisher node 202B and a second subscriber node 206B may be associated with the first transportation provider or a second transportation provider which may be different from the first transportation provider.

The message broker 204 may include suitable logic, circuitry, code, and/or interfaces that may be configured to route transaction messages from a publisher node (such as the first publisher node 202A) to a subscriber node (such as the first subscriber node 206A). Decisions to authorize the message broker 204 to route such transaction messages to the subscriber nodes may be determined by a server (not shown in FIG. 1) associated with the MaaS network 112. Example implementations of the message broker 204 may include, but are not limited to, an application server, a cloud server, a mainframe server, a database server, a web server, or other type of servers.

The message broker 204 may be configured to communicate with each of the set of publisher nodes 202A, 202B . . . 202N and the set of subscriber nodes 206A, 206B . . . 206N through a suitable publish-subscribe network protocol, such as, but not limited to, a MQTT-based messaging protocol, an AMQP-based messaging protocol, or a Message-Oriented Middleware (MOM)-based messaging framework.

The plurality of MP nodes 208A, 208B . . . 208N may include suitable logic, circuitry, code, and/or interfaces that may be configured to store transaction data associated with a respective mobility provider. For example, a first MP node 208A may store transaction data associated with a first mobility provider. The transaction data may include records of trips of users. Each trip may correspond to a MaaS transportation service that may be provided by the first transportation provider in at least one leg of the trip. Each of the plurality of MP nodes may be referred to as nodes of the first distributed ledger 208 that may store transaction data of the various mobility providers of the MaaS network 112.

The plurality of MaaS nodes 210A, 210B . . . 210N may include suitable logic, circuitry, code, and/or interfaces that may be configured to store transaction data associated with all mobility providers of the MaaS network 112. The storage of the transaction data associated with each of the transportation service providers may be used to settle payments amongst the transportation service providers for transportation services offered to users. Each of the plurality of MaaS nodes 210A, 210B . . . 210N may correspond to nodes of the second distributed ledger 210 that may store transaction data associated with the MaaS network 112.

Each of the plurality of the MP nodes 208A-208N and each of the plurality of MaaS nodes 210A, 210B . . . 210N may be associated with the set of distributed ledger nodes 212. For e.g., each of the first MP node 208A and the first MaaS node 210A may be associated with the driver node 212A, the user node 212B, and the document node 212C.

The set of subscriber nodes 206A, 206B . . . 206N may be associated with a corresponding node of the first distributed ledger 208. For example, the first subscriber node 206A may be associated with the first MP node 208A of the first distributed ledger 208, the second subscriber node 206B may be associated with a second MP node 208B of the first distributed ledger 208, . . . and so on.

In an embodiment, at least two ledger nodes of each of the first distributed ledger 208 and the second distributed ledger 210 may store transaction data associated with a MaaS transportation service. The MaaS transportation service may be associated with one or more of: the plurality of transportation providers and/or a user (for example, a passenger) who may avail the MaaS transportation service through a unified MaaS interface or through the set of publisher nodes 202A, 202B . . . 202N. The transaction data associated with the MaaS transportation service may be included in a set of state objects, such as an initial state object and an updated version of the initial state object. Each state object may include a smart contract, a contract code (or rules of a transaction upon which parties to the transaction agree), and state properties (that may be updated when the transaction data is updated based on transaction requests from the set of publisher nodes 202A, 202B . . . 202N).

In at least one embodiment, each of the first distributed ledger 208 and the second distributed ledger 210 may be a decentralized and distributed database system that may maintain an immutable record of data operations or transactions. For example, the transactions may include records pertaining to the consumption pattern of an NFT (as described in FIG. 1) or the sale of the NFTs via the NFT marketplace 110. A set of data operations may be grouped together as a block and may be further linked to a previous block of data operations to form a chain of a plurality of blocks. All blocks of data operations may be stored in a decentralized manner, in which at least two participants or nodes of each of the first distributed ledger 208 and the second distributed ledger 210 may store a subset of the plurality of blocks associated with one or more transactions in which the at least two participants or nodes may participate. Further, each of the first distributed ledger 208 and the second distributed ledger 210 may include an operating system (for example, a Java Virtual Machine (JVM)) which may allow deployment of a smart contract between multiple parties, for example, mobility provider node(s) of the first transportation provider) and a counter-party node (i.e., the MaaS provider node).

By way of example, and not limitation, each of the first distributed ledger 208 and the second distributed ledger 210 may be a distributed ledger technology (DLT) system, such as, blockchain based system (for example, a Corda blockchain, an Ethereum® blockchain, or a Hyperledger blockchain). Each of the first distributed ledger 208 and the second distributed ledger 210 may store a set of immutable state objects that may be tracked by the first distributed ledger 208 and the second distributed ledger 210, respectively. The state object may include a set of distributed ledger compatible rules for different types of distributed ledger technologies. For example, the state object may include transaction data, such as, a smart contract between parties, contract code (rules of transaction), and content including state properties with certain state values. The smart contract may include a set of conditions under which multiple parties to the smart contract may agree to interact with each other. The smart contract may run on one or more nodes of each of the first distributed ledger 208 and the second distributed ledger 210 and may govern transitions between state objects to generate a transaction. The smart contract may be written once, reused for a large numbers of state objects, and may refer to a governing legal prose by way of cryptographic hashes.

Each of the first distributed ledger 208 and the second distributed ledger 210 may use secure cryptographic hashes to identify parties and data and also to link a state object to a previous version of the state object to provide chains of provenance. A transaction between a group of parties may be stored on the first distributed ledger 208 and the second distributed ledger 210 such that only the group of parties associated with the transaction may be able to view the transaction. A party associated with a transaction may store a current state object of the transaction in a vault (a database associated with a respective distributed ledger, such as, the first distributed ledger 208 and the second distributed ledger 210). Another party eligible to view or process the transaction (e.g., validate the transaction) may retrieve the current state object of the transaction from the vault. Additionally, each state object of each of the first distributed ledger 208 and the second distributed ledger 210 may include a smart contract between the parties or nodes that may participate in an associated transaction.

On each of the first distributed ledger 208 and the second distributed ledger 210, a participant or a node (for example, the first MP node 208A) may update a transaction by updating state properties of an input state object (for example, the first state object) to produce an output state object (for example, the second state object). The updated transaction may thereby create a chain of provenance (which may be associated with the transaction data). Each of the first distributed ledger 208 and the second distributed ledger 210 may provide a consensus for the updated transaction based on a determination of a validity of the updated transaction and a determination of a uniqueness of the updated transaction. In an embodiment, the participants of nodes associated with the updated transaction may determine the validity of the updated transaction by an independent execution of smart contracts and validation logic associated with the transaction. Further, a consensus node associated with the each of the first distributed ledger 208 and the second distributed ledger 210 may determine the uniqueness of the updated transaction based on a check that there exists no other transaction that has reached a consensus by use of the same input state object as the current transaction.

FIGS. 3A and 3B collectively illustrate an exemplary sequence of operations for data provisioning using non-fungible tokens, in accordance with an embodiment of the disclosure. FIGS. 3A and 3B are explained in conjunction with elements from FIG. 1 and FIG. 2. With reference to FIGS. 3A and 3B, there is shown an exemplary sequence diagram 300 that illustrates exemplary operations from 302 to 328. The exemplary operations from 302 to 328 may be executed by any computing system, for example, by components of the system 100 of FIG. 1. The exemplary sequence diagram 300 further illustrates the data collection system 102, the owner device 104, the middleware system 106, the NFT marketplace 110, the mobility-as-a-service (MaaS) network 112, the user device 114, the analytics system 116, and the ML model 126.

At 302, a request for onboarding may be received. The data collection system 102 may receive the request for onboarding of the data owner 130 for the purpose of submitting the dataset owned by the data owner 130 to the data collection system 102. The request for onboarding may be received via a user input provided by the data owner 130 from the owner device 104. As an example, an interface of a data collection application may be rendered on the owner device 104. The interface of the data collection application may receive information, such as a name of the data owner 130, a type of data owned by the data owner 130 (for example, travel data), a volume of the data (for example, 100 kilobytes of the data) owned by the data owner 130, and the like. The received information may be transmitted to the data collection system 102.

At 304, mobility service data may be received. In an embodiment, the data collection system 102 may receive mobility service data associated with a set of past trips undertaken by the data owner 130 via a plurality of mobility service providers. The mobility service providers may be transport providers whose services may have been used by the data owner 130 to travel from one place to another place. In one trip, the data owner 130 may use multiple mobility service providers. For example, a data owner such as the data owner 130 may use a ride hailing service (e.g., cab service) for a first leg of the trip, a train service for a second leg of the trip, and a flight service for a third leg of the trip. The set of past trips may include information associated with each trip taken by the data owner 130 in the past. For example, the information associated with a trip may include, a date of the trip, a time duration of the trip, a number of mobility providers involved in the trip, a payment mode of the trip, and the like. The mobility service data associated with the set of past trips may include the information associated each trip of the set of past trips.

The data collection system 102 may execute a master service agreement between the data owner 130 and a data operator associated with the system (such as an entity that manages operations of the system 100 or the data collection system 102). The master service agreement may include legal terms and conditions that the data owner 130 may need to agree as a part of the onboarding process. For example, the master service agreement may state that the data owner 130 agrees to share the mobility service data with the data collection system 102. Further, the master service agreement may require that the mobility service data is an untampered version of user's mobility data. The master service agreement (MSA) may also state that the data owner 130 guarantees that the data owner 130 is a sole owner of the data. Further, the master service agreement (MSA) may also state that the data owner 130 guarantees that the information provided by the data owner 130 during the onboarding process is authentic.

Once the data owner 130 agrees to the master service agreement, the data collection system 102 may process the mobility service data and may extract the dataset from the mobility service data based on the execution of the master service agreement. The dataset may be stored after the extraction on the storage device 124. It may be noted that the mobility service data may be a raw version of the dataset. Hence, the mobility service data may contain redundant information that may be discarded to extract the dataset.

The data collection system 102 may define a data structure (or a schema) for the dataset and a data type for each attribute of the dataset. As an example, a decision tree may be used to extract the dataset that may be of highest value to create the NFT 128. The ownership information of the mobility service data may be eliminated from the dataset. In an example, various attributes like a gender of the data owner 130, a travel duration of a trip, and a location travelled in the trip may be collected from ticket data and may be used to decide a value of dataset. In an embodiment, the data collection system 102 may define a data catalog with logical groupings to extract the dataset. For example, the data collection system 102 may group datapoints in the mobility service data based on a type of mobility provider, a mode of transport, a geolocation, and the like. As an example, the mobility service data may include a trip identifier for a trip, a set of locations that the data owner 130 may have covered in the trip, a set of mobility providers used by the data owner 130 in the trip, and a payment mode used by the data owner 130 in the trip, and the like. The payment mode or other payment related information may be confidential data that the data collection system 102 may filter while extracting the dataset from the mobility service data.

At 306, it may be determined whether an NFT should be created for the dataset. The data collection system 102 may decide whether the NFT 128 should be created for the dataset based on conditions for the creation of the NFT 128. The creation of the NFT 128 may depend on factors, such as a size of the dataset, a type of the dataset, a type of attribute used in the dataset, a value (e.g., in terms of a monetary value or a demand in market) of the dataset, and the like. For example, the type of the dataset may be an authentic type or an altered type. If the dataset is not authentic, then the data collection system 102 may decide not to create the NFT 128 at 308. The sequence diagram 300 may be aborted at 308. However, if the dataset is authentic, then the data collection system 102 may decide to create the NFT 128. It should be noted that the data collection system 102 may create the NFT 128 by using standard token specifications like ERC-721, ERC-1155, and the like. The dataset may be categorized as an asset and represented via the NFT 128 on the distributed ledger 108. The distributed ledger 108 may also include ownership information associated with the data owner 130 to indicate that the NFT 128 is owned by the data owner 130.

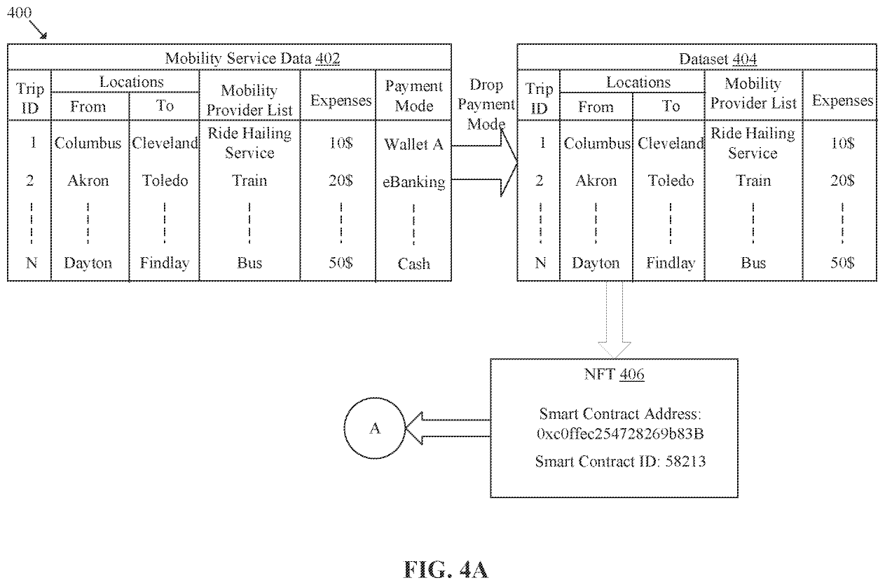

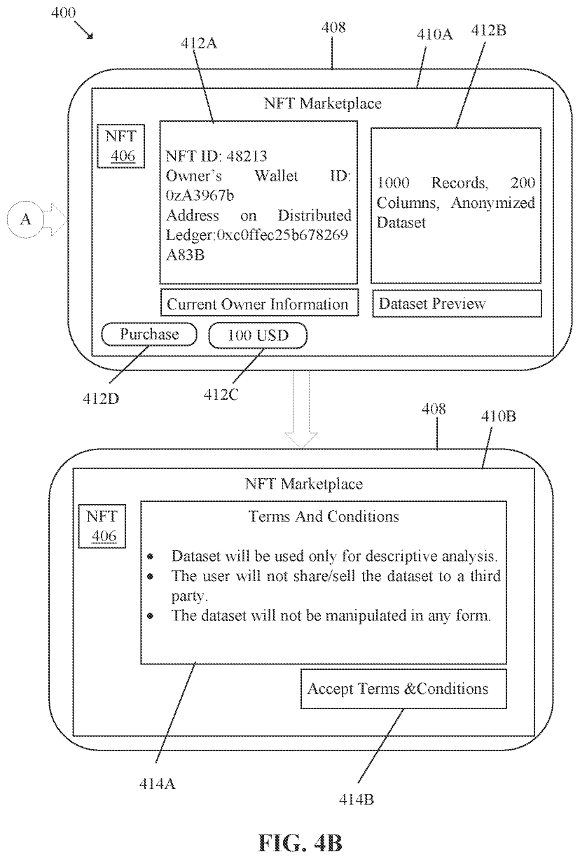

At 310, the NFT may be listed on the NFT marketplace 110. Once the NFT 128 is created, the data collection system 102 may list the created NFT 128 on the NFT marketplace 110 associated with the distributed ledger 108. The listing of the NFT 128 may include the ownership information associated with the data owner 130 and a preview of the dataset along with the NFT 128. As an example, each NFT listed on the NFT marketplace 110 may be tagged with related meta-data (such as, the ownership information and the preview) to help buyers (for example, the data user 132) understand datasets that are listed on the NFT marketplace 110. This may allow buyers (for example, the data user 132) to view, search, filter and purchase the dataset as per their requirements. Details related to the listing of the created NFT 128 are further provided, for example, in FIG. 4B.

At 312, the dataset may be stored on the storage device 124 associated with the middleware system 106. The data collection system 102 may store the dataset on the storage device 124 after the creation of the NFT 128. In an embodiment, the dataset may be classified and may be pre-processed based on the classification before the dataset is stored on the storage device 124. For example, the dataset may be classified into one of a set of classes (e.g., anonymized, safe, raw, etc.) based on whether the dataset includes personal identifiable information (PII), financial information, demographic details, and the like. In an embodiment, the dataset may be anonymized before the dataset is stored on the storage device 124. For example, values related to PI I in the dataset may be removed or replaced with numeric or alphanumeric identifiers to obtain an anonymized version of the dataset. The anonymized version of the dataset may be stored on the storage device 124. In another embodiment, the dataset may be stored on the storage device 124 in an encrypted form and/or an anonymized form after the creation of the NFT 128. The encryption of the dataset may ensure that the dataset is securely stored on the storage device 124. This may prevent any unauthorized person or device from accessing the dataset.

At 314, a purchase request may be received on the NFT marketplace 110. Before the purchase request is received, the data user 132 may sign up or register as a website user on the NFT marketplace 110. The NFT marketplace 110 may authenticate the data user 132 based a user identification (ID) and a password associated with data user 132. Once the data user 132 is authenticated, the NFT marketplace 110 may provide an option to the data user 132 to link a wallet associated with the data user 132 with the user identification. The middleware system 106 may request a smart contract (such as the first smart contract or the second smart contract) via an administrative wallet or a privilege wallet to record a public address of the data user 132 as a whitelisted user. Thereafter, the NFT marketplace 110 may receive the purchase request for the NFT 128 from the account of the data user 132. As discussed, the NFT 128 may be listed on the NFT marketplace 110. In an example, the data user 132 may interact with a user interface (UI) element associated with the NFT 128 on the NFT marketplace 110 to select the NFT 128. The purchase request for the NFT 128 may be received based on the interaction of the data user 132 with the UI element.

In an embodiment, the data owner 130 associated with the owner device 104 may specify verifiable credentials that contain information such as eligibility criteria to purchase the NFT asset during the onboarding. Such credentials associated with the data user 132 may be verified via the middleware system 106 to determine whether the data user 132 should be allowed to purchase the listed NFT 128.

The data collection system 102 may accept the purchase request if the purchase request satisfies terms associated with a sale of the NFT 128. Thereafter, a digital asset, such as money, digital fiat currency, cryptocurrency, or coupons may be transferred from the account of the data user 132 to an account of the data owner 130 or to an account of the data operator associated with the data collection system 102 as payment towards the purchase of the NFT 128.

In an embodiment, the terms associated with the sale of the NFT 128 may include one or more of a number of times a download of the dataset is allowed for the data user 132, a restriction on a time duration of downloading the dataset by the data user 132, a restriction on access to a raw version of the dataset represented by the NFT 128, a restriction to access the dataset based on a location of the data user 132, a restriction on a resale of the dataset by the data user 132, a restriction on access to aggregated data of the dataset, a restriction on a number of allowable copies of the dataset, a restriction on a purpose of a purchase of the NFT 128, or a restriction on access to an anonymized version of the dataset. The number of times that the download of the dataset is allowed for the data user 132 may prevent the data user 132 from downloading the dataset incessantly. For example, the number of times that the download of the dataset is allowed may be two. The data user 132 may not be allowed to download the dataset after the dataset has been downloaded twice. The restriction on the time duration of downloading the dataset may provide a time window within which the dataset can be downloaded or accessed on the analytics system 116. For example, the time duration of downloading the dataset may be two weeks from a date of purchase of the dataset. The data user 132 may not be able to download the dataset after two weeks from the date of purchase of the dataset. The restriction on access to the raw version of the dataset represented may state whether the raw version of the dataset should be accessed by the data user 132. For example, the restriction on the access to the raw version of the dataset may mandate that only the encrypted form or the anonymized form of the dataset should be made accessible to the data user 132. The restriction to access the dataset based on the location of the data user 132 may require that the location of the data user 132 should be within a predefined geographical area in order to access the dataset. If the location of the data user 132 is not within the predefined geographical area, then the dataset may not be made accessible to the data user 132. The restriction on the resale of the dataset may prevent the data user 132 from reselling the dataset to any person who is not a valid owner of the dataset. The restriction on access to aggregated data of the dataset may specify whether the aggregated data should be accessible to the data user 132. The aggregated data may be a summary of dataset, for example. The restriction on a number of allowable copies of the dataset may specify a maximum number of copies of the dataset that the data user 132 is allowed to sell. The restriction on the purpose of the purchase of the NFT 128 may prevent the data user 132 from purchasing the NFT 128 for purposes other than a predefined purpose. For example, the restriction on the purpose of the purchase of the NFT 128 may require that the dataset be used only for descriptive analytics. Thus, if the purpose of the purchase of the NFT 128 is not for descriptive analytics, then the purchase request received from the from the account of the data user 132 may be rejected. The restriction on the access to the anonymized version of the dataset may specify whether the data user 132 should have access to the anonymized version.

The data collection system 102 may update ownership information of the NFT 128 on the distributed ledger 108 to include the data user 132 based on whether the purchase request satisfies terms associated with the sale of the NFT 128. If the purchase request satisfies terms associated with the sale of the NFT 128, then the ownership information of the NFT 128 may be updated to include the account of the data user 132. That is, the NFT 128 may be transferred to the account of the data user 132.

At 316, an access request may be received by the middleware system 106. Once the NFT 128 is purchased, the middleware system 106 may receive an access request for the dataset from the analytics system 116. For example, the analytics system 116 may transmit the access request (e.g., an HTTP request or a webhook) to download the dataset from the middleware system 106.

At 318, ownership verification may be performed. Upon reception of the access request, the middleware system 106 may verify the ownership information associated with the access request. The middleware system 106 may verify whether the account used for requesting access or download of the dataset is the same account from which the purchase request is received. Specifically, the ownership verification may be performed verify whether the data user associated with the analytics system 116 is same as the data user who purchased the NFT 128.

Once the ownership information is verified, the data collection system 102 may verify whether the access request satisfies the terms associated with the usage of the dataset. In an embodiment, the terms associated with the usage of the dataset may include a term to provide an access to the dataset based on whether the data user 132 accepted the service agreement at the time of the purchase of the NFT 128, a restriction on the usage of the dataset based on a status of the data user 132, or an allowance on a streaming of the dataset to the analytics system 116. The status of the data user 132 may be a whitelist status or a blacklist status. The service agreement may include a set of terms and conditions that the data user 132 may need to agree in order to access the dataset (represented by the NFT 128). In case the data user 132 does not agree with the terms and conditions of the service agreement, then the data user 132 may be prevented from using the dataset. The service agreement may be a binding agreement between the data user 132 and the data owner 130. In an embodiment, the service agreement may also include the terms associated with the sale of the NFT 128.

The restriction on the usage of the dataset may prevent the data user 132 from using the dataset if the data user 132 is associated with a blacklist status. The data collection system 102 may often blacklist data users who may be found to have violated access rules for the dataset, or the terms associated with the usage of the dataset in past. Such users may be provided a blacklist status and may be prevented from using the dataset in future.

The allowance to stream the dataset to the analytics system 116 may state conditions based on which the dataset may streamed to the analytics system 116. For example, the allowance to stream the dataset to the analytics system 116 may state that the dataset that can be processed on-the-fly by the analytics system 116 may be streamed in data subsets of “100” kilobytes size.

Once the data collection system 102 verifies that the access request satisfies the terms associated with the usage of the dataset, a request to audit and track the consumption of the dataset associated with NFT 128 may be received by the MaaS network 112 at 320. The MaaS network 112 may receive the request to audit and track the NFT 128 from the middleware system 106. The MaaS network 112 may validate, audit, and track the consumption of the dataset associated with the NFT 128 for a duration for which the service agreement between the data user 132 and the data owner 130 is valid.

At 322, a request to verify whether the access request satisfies access rules for the dataset may be received by the ML model 126. The ML model 126 may verify whether the access request satisfies access rules for the dataset from the MaaS network 112. In an embodiment, the access rules for the dataset may include one or more of a list of valid analytics on the dataset, a duration for which the dataset is accessible or downloadable on the analytics system 116, a number of participants that are allowed to work on the dataset through the analytics system 116, or a location in which the dataset is downloadable or accessible via the analytics system 116. The list of valid analytics on the dataset may prevent the execution of any undesired operation on the dataset other than ones in the list of valid analytics. As an example, the list of valid analytics may include an operation to predict a demand for a particular mobility provider who may have rendered services to the data owner 130 in the past, an operation to determine a price that the data owner 130 typically prefers to pay for the services, an operation to determine key locations that the data owner 130 prefers to visit, and the like.

The duration for which the dataset is accessible or downloadable on the analytics system 116 may be refer to a time window in hours, days, weeks, or months. The analytics system 116 may not be allowed to access or download the dataset after the duration. For example, the duration may be two weeks from the date of purchase of the NFT 128. The analytics system 116 may not be allowed to access or download the dataset after two weeks from the date of purchase of the NFT 128.

The number of participants that may be allowed to work on the dataset through the analytics system 116 may correspond to a number of users that may work on the dataset through the analytics system 116. For example, the number of participants that may be allowed to work on the dataset may be at most one.

The location in which the dataset is downloadable or accessible via the analytics system 116 may correspond to a geographical area. All access requests that may originate from the area may be accepted by the MaaS network 112. Access requests from other areas may be rejected by the MaaS network 112.

In an embodiment, the terms associated with the sale of the NFT 128, the access rules for the dataset, or the terms associated with the usage of the dataset may be described in the first smart contract on the distributed ledger 108 or the second smart contract on a ledger node of the MaaS network 112. The access request may be validated by executing the first smart contract on the distributed ledger 108 or the second smart contract on the ledger node of the MaaS network 112. For example, if the terms associated with the sale of the NFT 128, the access rules for the dataset, or the terms associated with the usage of the dataset are described in the first smart contract on the distributed ledger 108, then the first smart contract on the distributed ledger 108 may be executed to determine whether the purchase request for the NFT 128 satisfies the terms associated with the sale of the NFT 128. The first smart contract on the distributed ledger 108 may be further executed to determine whether the access request satisfies the access rules for the dataset, or the terms associated with the usage of the dataset (as described in the first smart contract on the distributed ledger 108).

In accordance with an embodiment, the ML model 126 may be configured to verify whether the access request satisfies the access rules for the dataset (as shown in FIG. 3B). In some embodiments, a subset of complex access rules may be externalized from the first smart contract or the second smart contract to the ML model 126. The data collection system 102 may validate the access request based on the ownership information and further based whether the access request satisfies at least one of access rules for the dataset and terms associated with the usage of the dataset.

At 324, a request to update information associated the NFT 128 on the NFT marketplace 110 may be received by the data collection system 102. Once the access request is validated, the data collection system 102 may update the information associated with the access of the dataset on the first smart contract on the distributed ledger 108 so that the analytics system 116 may access or download the dataset. The information associated the NFT 128 may be updated on NFT marketplace 110 and the NFT marketplace 110 may notify the data user 132 that the analytics system 116 associated with the data user 132 may access or download the dataset.

At 326, an encrypted copy of the dataset may be provided to the analytics system 116. The analytics system 116 may receive the encrypted copy of the dataset from the middleware system 106. The middleware system 106 may provide the encrypted copy of the dataset so that the dataset can be securely accessed only by authorized users.

At 328, an operation of decryption of the received encrypted copy of the dataset may be executed. In an embodiment, the data collection system 102 may share a private key with the account of the data user 132 based on the validation of the access request to the analytics system 116. The analytics system 116 may decrypt the encrypted copy of the dataset based on the received private key to obtain the dataset in an unencrypted form. In an embodiment, the private key may be retrieved from the distributed ledger 108 and the analytics system 116 may use the account of the data user 132 and the private key to decrypt the encrypted copy of the dataset. Thereafter, the analytics system 116 may perform analytics on the unencrypted form of the dataset. For example, analytics system 116 may analyze the unencrypted form of the dataset to determine the mode of transport that may be most frequently used by the data owner 130 and the places that are frequently visited by the data owner 130.

The data collection system 102 may monitor the analytics performed on the unencrypted form of the dataset to determine the consumption pattern of the served copy on the analytics system 116. For example, the consumption pattern may include the analytic operation performed on the unencrypted form of the dataset and a number of times the analytics is performed on the unencrypted form of the dataset. Further, the consumption pattern may include a number of downloads of the dataset, a forging attempt to fake the user account to gain access to the dataset, an attempt to resell the dataset, an attempt to tamper with the dataset, an attempt to transfer the dataset out of the analytics system 116, and the like.

The data collection system 102 may control the access to the copy of the dataset on the analytics system 116 based on the consumption pattern. In an embodiment, the data collection system 102 may determine a violation of the terms associated with the sale of the NFT 128, the access rules for the dataset, or the terms associated with the usage of the dataset based on the consumption pattern. For example, in case the analytics performed on the unencrypted form of the dataset is determined as an invalid (or unsafe) analytics, then the data collection system 102 may determine the operation as a violation of the terms associated with the usage of the dataset.

In an embodiment, the violation may be determined by use of the ML model 126. The ML model 126 may be trained to determine the violation based on the consumption pattern. The ML model 126 may receive the consumption pattern as an input and may determine the violation based on analysis of the consumption pattern. As an example, the data user 132 may try to resell the dataset to another party. The consumption pattern may contain information associated with attempts to resell the dataset. The ML model 126 may determine the violation of the terms associated with the sale of the NFT 128 based on the attempts in the consumption pattern. The ML model 126 may also determine malicious practices of the data user 132 or may detect unfair consumption of the dataset (for example, exceeding inventory limits provided in the terms associated with the sale of the NFT 128). The detection of the violation may cause the data user 132 to lose access to the dataset on the analytics system 116. In some instances, the data collection system 102 may issue a warning to the data user or may block the data user 132 for a definite or an indefinite period of time.

In an embodiment, the data collection system 102 or the ML model 126 may generate a feedback based on the determination of the violation. The generated feedback may be transmitted to the user device 114. The data collection system 102 may control the user device 114 associated with the data user 132 to render the feedback. For example, a notification may popup on the user device 114 associated with the data user 132. The notification may state that the violation of terms of usage has been determined on the analytics system 116. In an embodiment, the generated feedback may be transmitted to the data collection system 102. The data collection system 102 may control the middleware system 106 to block access to the copy of the dataset or the encrypted copy of the dataset for the analytics system 116.

FIGS. 4A and 4B are diagrams that collectively illustrate an exemplary scenario for data provisioning using non-fungible tokens, in accordance with an embodiment of the disclosure. FIGS. 4A and 4B are explained in conjunction with elements from FIG. 1, FIG. 2, FIG. 3A, and FIG. 3B. With reference to FIGS. 4A and 4B, there is shown an exemplary scenario 400. The exemplary scenario 400 may include mobility service data 402, a dataset 404, a NFT 406, a user device 408, a user interface (UI) 410A, a first UI element 412A, a second UI element 412B, a third UI element 412C, a fourth UI element 412D, a user interface (UI) 410B, a fifth UI element 414A, and a sixth UI element 414B. A set of operations associated with the exemplary scenario is described herein.

During operation, the data collection system 102 may receive the mobility service data 402 from an owner device (for example, the owner device 104). The mobility service data 402 may be a raw dataset associated with a travel history of a data owner (for example, the data owner 130). The mobility service data 402 may include information associated with “N” number of trips taken by the data owner 130. For each trip, a trip identifier (ID) associated with the trip, a name of location visited by the data owner 130 in the trip, an expense incurred in the trip, a mobility provider used for travelling in the trip, and a payment mode used in the trip may be specified. For example, it may be observed from the mobility service data 402 that for a trip with trip ID “1”, the data owner 130 may have travelled from Columbus to Cleveland using one or more ride hailing services. Further, the expense incurred in the trip with trip ID “1” may be ten dollars, and the data owner 130 may have used a wallet “A” for payment.

The data collection system 102 may extract the dataset 404 from the mobility service data 402. The mobility service data 402 may be filtered to exclude certain confidential information included in the mobility service data 402. For example, the mobility service data 402 may be filtered by removing the payment mode column from the mobility service data 402.

The data collection system 102 may create the NFT 406 on a distributed ledger, such as the distributed ledger 108. When an NFT is minted, the data collection system 102 may store custom meta-data. Meta-data may include information, such as owner information, Uniform Resource Identifier (URI) that may be linked with the dataset that is present off-chain and is a source of truth, and the like. The terms associated with the sale of the NFT 406, the access rules for the dataset, or the terms associated with the usage of the dataset may be described in a smart contract, such as the first smart contract on the distributed ledger 108. The NFT 406 may include information associated with an address of the smart contract and a smart contract identification (ID) associated with the smart contract. With reference to FIG. 4A, the address of the smart contract may be “0xc0ffec254728269683B” and the smart contract ID may be “58213”.

The NFT 406 may be listed on a NFT marketplace, such as the NFT marketplace 110. The NFT marketplace 110 may be accessed via a web client on the user device 408. With reference to FIG. 4B, the NFT 406 is shown as a listing on the first UI 410A of the NFT marketplace 110. The first UI 410A may be associated with the first UI element 412A, the second UI element 412B, the third UI element 412C, and the fourth UI element 412D. The first UI element 412A may provide information associated with a current owner (for example, the data owner 130) of dataset 404. The information may include, for example, NFT ID, owner's wallet ID, and address of the NFT 406 on the distributed ledger 108. The first UI element 412A may state that the NFT ID for the NFT 406 may be “48213”, the owner's wallet ID associated with the data owner 130 may be “0zA3967b” and the address of the NFT 406 on the distributed ledger 108 may be “0xc0ffec25b678269A83B”.

The second UI element 412B may provide a preview of the dataset 404 associated with the NFT 406. With reference to FIG. 4B, the second UI element 412B may state that the dataset 404 associated with the NFT 406 includes 1000 records, 200 columns, and is an anonymized version. The third UI element 412C may include a price of the NFT 406. With reference to FIG. 4B, the third UI element 412C may state that the price of the NFT 406 is 100 dollars. The data user 132 may analyze the information associated with the current owner (for example, the data owner 130) of dataset 404, the preview of the dataset 404 associated with the NFT 406, and the price of the NFT 406 to decide whether to purchase the NFT 406. The NFT marketplace 110 may receive the request to purchase the NFT 406 based on an interaction of the data user 132 with the fourth UI element 412D.

Once the request to purchase the NFT 406 is received by the NFT marketplace 110, the NFT marketplace 110 may switch to the second user interface 410B. The second user interface 410B may be displayed on the user device 408. The second user interface 410B may provide the fifth UI element 414A and the sixth UI element 414B. The fifth UI element 414A may provide terms and conditions associated with the NFT 406. With reference to FIG. 4B, the terms and conditions provided in fifth UI element 414A may require that the dataset 404 be used only for descriptive analysis, the data user 132 must not share or sell the dataset 404 to a third party, and the dataset 404 should not be manipulated or tampered with in any form. The data user 132 may read the terms and conditions associated with the NFT 406 and may decide to purchase the NFT 406. The NFT marketplace 110 may receive an acceptance for the terms and conditions provided in the fifth UI element 414A based on a selection of the sixth UI element 414B. Thereafter, a payment of 100 dollars may be made from the account of the data user 132 to the account of the data owner 130 or the data collection system 102.

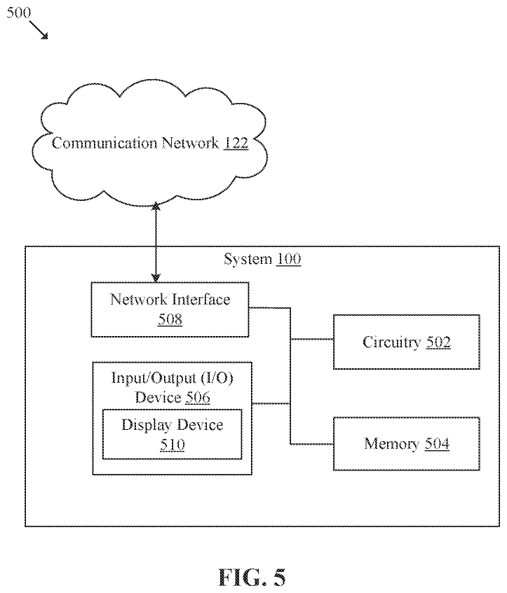

FIG. 5 is a block diagram that illustrates an exemplary data collection system of FIG. 1, in accordance with an embodiment of the disclosure. FIG. 5 is explained in conjunction with elements from FIG. 1, FIG. 2, FIG. 3A, FIG. 3B, FIG. 4A, and FIG. 4B. With reference to FIG. 5, there is shown a block diagram 500 of the system 100 of FIG. 1. The system 100 may include circuitry 502, a memory 504, an input/output (I/O) device 506, and a network interface 508. The input/output (I/O) device 506 may include a display device 510.

The circuitry 502 may include suitable logic, circuitry, and/or interfaces that may be configured to execute program instructions associated with different operations to be executed by the data collection system 102. The circuitry 502 may include one or more processing units, which may be implemented as a separate processor. In an embodiment, the one or more processing units may be implemented as an integrated processor or a cluster of processors that perform the functions of the one or more specialized processing units, collectively. The circuitry 502 may be implemented based on a number of processor technologies known in the art. Examples of implementations of the circuitry 502 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 504 may include suitable logic, circuitry, interfaces, and/or code that may be configured to store one or more instructions to be executed by the circuitry 502. The memory 504 may be configured to the dataset. Examples of implementation of the memory 504 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 506 may include suitable logic, circuitry, interfaces, and/or code that may be configured to receive an input and provide an output based on the received input. For example, the I/O device 506 may receive a first user input indicative of a request for onboarding. The I/O device 506 may include the display device 510. Examples of the I/O device 506 may include, but are not limited to, a touch screen, a keyboard, a mouse, a joystick, a microphone, or a speaker.

The network interface 508 may include suitable logic, circuitry, interfaces, and/or code that may be configured to facilitate communication between the data collection system 102 and the server 118 via the communication network 122. The network interface 508 may be implemented by use of various known technologies to support wired or wireless communication of the data collection system 102 with the communication network. The network interface 508 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 508 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 510 may include suitable logic, circuitry, and interfaces that may be configured to display information associated with the dataset and terms associated with the sale of the NFT 128. The display device 510 may be a touch screen which may enable a user (e.g., the data owner 130) to provide a user-input via the display device 510. The touch screen may be at least one of a resistive touch screen, a capacitive touch screen, or a thermal touch screen. The display device 510 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 510 may refer to a display screen of a head mounted device (HMD), a smart-glass device, a see-through display, a projection-based display, an electro-chromic display, or a transparent display.

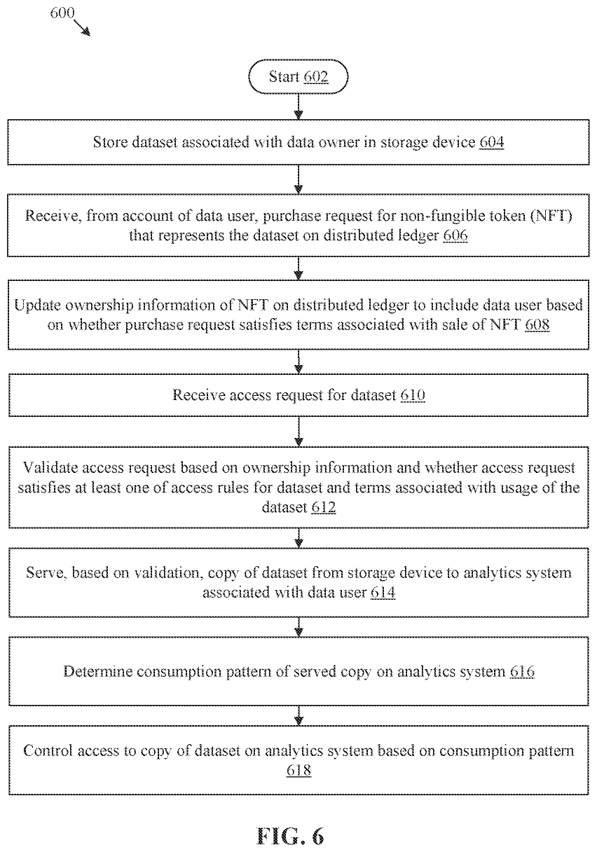

FIG. 6 is a flowchart that illustrates operations of an exemplary method for data provisioning using non-fungible tokens, in accordance with an embodiment of the disclosure. FIG. 6 is explained in conjunction with elements from FIG. 1, FIG. 2, FIG. 3A, FIG. 3B, FIG. 4A, FIG. 4B, and FIG. 5. With reference to FIG. 6, there is shown a flowchart 600. The flowchart 600 may include operations from 602 to 618 and may be implemented by the data collection system 102, the owner device 104, the middleware system 106, the distributed ledger 108, the NFT marketplace 110, the MaaS network 112, the user device 114, the analytics system 116 of FIG. 1 or by the circuitry 502 of FIG. 2. The flowchart 600 may start at 602 and proceed to 604.

At 604, the dataset associated with the data owner 130 may be stored in the storage device 124. The data collection system 102 may control the middleware system 106 to store dataset associated with the data owner 130 in the storage device 124. Details related to the storage of the dataset are provided, for example, in FIG. 3A.

At 606, the purchase request for the NFT 128 from the account of the data user 132 may be received by the NFT marketplace 110. The NFT marketplace 110 may receive the purchase request for the NFT 128 from the account of the data user 132. The NFT 128 may represent the dataset on the distributed ledger 108. Details related to the purchase request are provided, for example, in FIG. 3A.

At 608, the ownership information of the NFT 128 may be updated on the distributed ledger 108 to include the data user 132 based on whether the purchase request satisfies terms associated with the sale of the NFT 128. The data collection system 102 may update ownership information of the NFT 128 on the distributed ledger 108 to include the data user 132 based on whether the purchase request satisfies terms associated with the sale of the NFT 128. Details related to the ownership information are provided, for example, in FIG. 3B.

At 610, the access request for the dataset may be received. The middleware system 106 may receive access request for the dataset. Details related to the access request are provided, for example, in FIG. 3B.

At 612, the access request may be validated based on the ownership information and whether the access request satisfies at least one of access rules for the dataset and terms associated with the usage of the dataset. The data collection system 102 may validate the access request based on the ownership information and whether the access request satisfies at least one of access rules for the dataset and terms associated with the usage of the dataset. Details related to the validation of the access request are provided, for example, in FIG. 3B.

At 614, the copy of the dataset may be served from the storage device 124 to the analytics system 116 associated with the data user 132. The data collection system 102 may control the middleware system 106 to serve the copy of the dataset from the storage device 124 to the analytics system 116 associated with the data user 132 based on the validation. Details related to the serving of the copy of the dataset are provided, for example, in FIG. 3B.

At 616, the consumption pattern of the served copy may be determined on the analytics system 116. The data collection system 102 may determine the consumption pattern of the served copy on the analytics system 116. Details related to the consumption pattern are provided, for example, in FIG. 3B.

At 618, the access to the copy of the dataset on the analytics system 116 may be controlled based on the consumption pattern. The data collection system 102 may control the access to the copy of the dataset on the analytics system 116 based on the consumption pattern. Details related to the control of the access to the copy of the dataset are provided, for example, in FIG. 3B. Control may pass to end.

Although the flowchart 600 is illustrated as discrete operations, such as, 604, 606, 608, 610, 612, 614, 616, and 618, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (for example, the data collection system 102 of FIG. 1). Such instructions may cause the data collection system 102 to perform operations that may include storing dataset associated with a data owner (for example, the data owner 130 of FIG. 1) in a storage device (for example, the storage device 124 of FIG. 1). The operations may further include receiving, from an account of a data user (for example, the data user 132 of FIG. 1), a purchase request for a non-fungible token (NFT) (for example, the NFT 128 of FIG. 1) that represents the dataset on a distributed ledger (for example, the distributed ledger 108 of FIG. 1). The operations may further include updating ownership information of the NFT 128 on the distributed ledger 108 to include the data user 132 based on whether the purchase request satisfies terms associated with a sale of the NFT 128. The operations may further include receiving an access request for the dataset. The operations may further include validating the access request based on the ownership information and whether the access request satisfies at least one of access rules for the dataset and terms associated with a usage of the dataset. The operations may further include serving, based on the validation, a copy of the dataset from the storage device 124 to an analytics system (for example, the analytics system 116 of FIG. 1) associated with the data user 132. The operations may further include determining a consumption pattern of the served copy on the analytics system 116. The operations may further include controlling an access to the copy of the dataset on the analytics system 116 based on the consumption pattern.

Exemplary aspects of the disclosure may provide a system (such as, the data collection system 102 of FIG. 1). The system may store dataset associated with a data owner (for example, the data owner 130 of FIG. 1) in a storage device (for example, the storage device 124 of FIG. 1). The system may receive, from an account of a data user (for example, the data user 132 of FIG. 1), a purchase request for a non-fungible token (NFT) (for example, the NFT 128 of FIG. 1) that represents the dataset on a distributed ledger (for example, the distributed ledger 108 of FIG. 1). The system may update ownership information of the NFT 128 on the distributed ledger 108 to include the data user 132 based on whether the purchase request satisfies terms associated with a sale of the NFT 128. The system may receive an access request for the dataset. The system may validate the access request based on the ownership information and whether the access request satisfies at least one of access rules for the dataset and terms associated with a usage of the dataset. The system may serve, based on the validation, a copy of the dataset from the storage device 124 to an analytics system (for example, the analytics system 116 of FIG. 1) associated with the data user 132. The system may determine a consumption pattern of the served copy on the analytics system 116. The system may control an access to the copy of the dataset on the analytics system 116 based on the consumption pattern.

In an embodiment, the data collection system 102 may receive the mobility service data 402 associated with the set of past trips undertaken by the data owner 130 via the plurality of mobility service providers. The data collection system 102 may execute the master service agreement between the data owner 130 and the data operator associated with the data collection system 102 may. The data collection system 102 may extract the dataset 404 from the mobility service data based on the execution, wherein the dataset 404 may be stored after the extraction on the storage device 124.

In an embodiment, the data collection system 102 may create the NFT 128 on the distributed ledger 108 based on whether the dataset 404 satisfies conditions for the creation of NFT 128. The data collection system 102 may list the created NFT 128 on the NFT marketplace 110 associated with the distributed ledger 108, wherein the listing of the NFT 128 may include ownership information associated with the data owner 130 and the preview of the dataset 404 that may be represented by the NFT 128.

In an embodiment, the dataset 404 may be stored on the storage device 124 in the encrypted form and/or the anonymized form after the creation of the NFT 128.

In an embodiment, the system may further include the MaaS network 112 that includes the message broker 204, the set of publisher nodes 202A, 202B, . . . 202N, the set of distributed ledger nodes 212, and the set of subscriber nodes 206A, 206B . . . 206N that communicates with the set of publisher nodes 202A, 202B, . . . 202N via the message broker for example, the message broker 204 of FIG. 2). The set of publisher nodes may be communicatively coupled to the distributed ledger 108.

In an embodiment, the terms associated with the sale of the NFT 128, the access rules for the dataset 404, or the terms associated with the usage of the dataset 404 may be described in the first smart contract on the distributed ledger 108 or the second smart contract on the ledger node of the MaaS network 112.

In an embodiment, the access request may be validated by executing the first smart contract on the distributed ledger 108 or the second smart contract on the ledger node of the MaaS network 112.

In an embodiment, the access rules for the dataset 404 may include one or more of: the list of valid analytics on the dataset 404, the duration for which the dataset 404 may be accessible or downloadable on the analytics system 116, the number of participants that may be allowed to work on the dataset 404 through the analytics system 116, or the location in which the dataset 404 may be downloadable or accessible via the analytics system 116.

In an embodiment, the terms associated with the sale of the NFT 128 may include one or more of: the number of times download of the dataset 404 may be allowed by the data user 132, the restriction on the time duration of downloading the dataset 404 by the data user 132, the restriction on the access to the raw version of the dataset 404 represented by the NFT 128, the restriction to access the dataset 404 based on the location of the data user 132, the restriction on the resale of the dataset 404 by the data user 132, the restriction on the access of aggregated data of the dataset 404 represented by the NFT 128, the restriction on the number of allowable copies of the dataset 404, the restriction on the purpose of the purchase of the NFT 128 by the data user 132, or the restriction on the access to anonymized version of the dataset 404 by the data user 132.

In an embodiment, the terms associated with the usage of the dataset 404 may include one or more of: the access to the dataset 404 represented by the NFT 128 based on the acceptance of the service agreement by the data user 132, the restriction on the usage of the dataset 404 based on the status of the data user 132, the allowance to stream the dataset 404 to the analytics system 116, and wherein the status of the data user 132 may be the whitelist status or the blacklist status.

In an embodiment, the data collection system 102 may share the private key with the account of the data user 132 based on the validation of the access request, wherein the copy of the dataset may be the encrypted copy. The analytics system 116 may decrypt the encrypted copy of the dataset 404 based on the private key to obtain the dataset in the unencrypted form.

In an embodiment, the violation of the terms associated with the sale of the NFT 128, the access rules for the dataset 404, or the terms associated with the usage of the dataset 404 based on the consumption pattern may be determined.

In an embodiment, the data collection system 102 may generate the feedback based on the determination of the violation. The data collection system 102 may control the user device 114 associated with the data user 132 to render the feedback.

In an embodiment, the violation may be determined by use of the ML model 126.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A method, comprising:
in a system that includes a storage device for storing a dataset associated with a data owner:
receiving, from an account of a data user, a purchase request for a non-fungible token (NFT) that represents the dataset on a distributed ledger;
updating ownership information of the NFT on the distributed ledger to include the data user based on whether the purchase request satisfies terms associated with a sale of the NFT;
receiving an access request for the dataset;
validating the access request based on the ownership information and whether the access request satisfies at least one of access rules for the dataset and terms associated with a usage of the dataset;
serving, based on the validation, a copy of the dataset from the storage device to an analytics system associated with the data user;
determining a consumption pattern of the served copy on the analytics system; and
controlling an access to the copy of the dataset on the analytics system based on the consumption pattern.

2. The method according to claim 1, further comprising:
receiving mobility service data associated with a set of past trips undertaken by the data owner via a plurality of mobility service providers;
executing a master service agreement between the data owner and a data operator associated with the system; and
extracting the dataset from the mobility service data based on the execution, wherein the dataset is stored after the extraction on the storage device.

3. The method according to claim 1, further comprising:
creating the NFT on the distributed ledger based on whether the dataset satisfies conditions for a creation of NFT; and
listing the created NFT on an NFT marketplace associated with the distributed ledger,
wherein the listing of the NFT includes ownership information associated with the data owner and a preview of the dataset that is represented by the NFT.

4. The method according to claim 3, wherein the dataset is stored on the storage device in an encrypted form or an anonymized form after the creation of the NFT. The method according to claim 1, wherein the system further includes a Mobility-as-a-Service (MaaS) network that includes a message broker, a set of publisher nodes, a set of distributed ledger nodes, and a set of subscriber nodes that communicates with the set of publisher nodes via the message broker, and
wherein the set of publisher nodes are communicatively coupled to the distributed ledger.

6. The method according to claim 5, wherein the terms associated with the sale of the NFT, the access rules for the dataset, or the terms associated with the usage of the dataset are described in a first smart contract on the distributed ledger or a second smart contract on a ledger node of the MaaS network.

7. The method according to claim 6, wherein the access request is validated by executing the first smart contract on the distributed ledger or the second smart contract on the ledger node of the MaaS network.

8. The method according to claim 1, wherein the access rules for the dataset include one or more of a list of valid analytics on the dataset, a duration for which the dataset is accessible or downloadable on the analytics system, a number of participants that are allowed to work on the dataset through the analytics system, or a location in which the dataset is downloadable or accessible via the analytics system.

9. The method according to claim 1, the terms associated with the sale of the NFT include one or more of: a number of times download of the dataset is allowed by the data user, a restriction on a time duration of downloading the dataset by the data user, a restriction on an access to a raw version of the dataset represented by the NFT, a restriction to access the dataset based on a location of the data user, a restriction on a resale of the dataset by the data user, a restriction on an access of aggregated data of the dataset represented by the NFT, a restriction on a number of allowable copies of the dataset, a restriction on a purpose of a purchase of the NFT by the data user, or a restriction on an access to anonymized version of the dataset by the data user.

10. The method according to claim 1, wherein the terms associated with the usage of the dataset include a term to provide an access to the dataset based on whether the data user accepted a service agreement at a time of a purchase of the NFT a restriction on the usage of the dataset based on a status of the data user, an allowance on a streaming of the dataset to the analytics system, and wherein the status of the data user is a whitelist status or a blacklist status.

11. The method according to claim 1, further comprising:
sharing a private key with the account of the data user based on the validation of the access request, wherein the copy of the dataset is an encrypted copy; and
decrypting the encrypted copy of the dataset based on the private key to obtain the dataset in an unencrypted form.

12. The method according to claim 1, further comprising determining a violation of the terms associated with the sale of the NFT, the access rules for the dataset, or the terms associated with the usage of the dataset based on the consumption pattern.

13. The method according to claim 12, further comprising:
generating a feedback based on the determination of the violation; and
controlling a user device associated with the data user to render the feedback.

14. The method according to claim 12, wherein the violation is determined by use of a machine learning (ML) model.

15. A system, comprising:
a storage device configured to store a dataset associated with a data owner; and
circuitry configured to:
receive, from an account of a data user, a purchase request for a non-fungible token (NFT) that represents the dataset on a distributed ledger;
update ownership information of the NFT on the distributed ledger to include the data user based on whether the purchase request satisfies terms associated with a sale of the NFT;
receive an access request for the dataset;
validate the access request based on the ownership information and whether the access request satisfies at least one of access rules for the dataset and terms associated with a usage of the dataset;
serve, based on the validation, a copy of the dataset from the storage device to an analytics system associated with the data user;
determine a consumption pattern of the served copy on the analytics system; and
control an access to the copy of the dataset on the analytics system based on the consumption pattern.

16. The system according to claim 15, wherein the circuitry is further configured to:
receive mobility service data associated with a set of past trips undertaken by the data owner via a plurality of mobility service providers;
execute a master service agreement between the data owner and a data operator associated with the system; and
extract the dataset from the mobility service data based on the execution, wherein the dataset is stored after the extraction on the storage device.

17. The system according to claim 15, wherein the circuitry is further configured to:
create the NFT on the distributed ledger based on whether the dataset satisfies conditions for a creation of NFT; and
list the created NFT on an NFT marketplace associated with the distributed ledger,
wherein the listing of the NFT includes ownership information associated with the data owner and a preview of the dataset that is represented by the NFT.

18. The system according to claim 17, wherein the dataset is stored on the storage device in an encrypted form or an anonymized form after the creation of the NFT.

19. The system according to claim 15, further comprising a Mobility-as-a-Service (MaaS) network that includes a message broker, a set of publisher nodes, a set of distributed ledger nodes, and a set of subscriber nodes that communicates with the set of publisher nodes via the message broker,
wherein the set of publisher nodes are communicatively coupled to the distributed ledger.

20. A non-transitory computer-readable medium having stored thereon, computer-executable instructions that when executed by a system, causes the system to execute operations, the operations comprising:
storing a dataset associated with a data owner in a storage device;
receiving, from an account of a data user, a purchase request for a non-fungible token (NFT) that represents the dataset on a distributed ledger;
updating ownership information of the NFT on the distributed ledger to include the data user based on whether the purchase request satisfies terms associated with a sale of the NFT;
receiving an access request for the dataset;
validating the access request based on the ownership information and whether the access request satisfies at least one of access rules for the dataset and terms associated with a usage of the dataset;
serving, based on the validation, a copy of the dataset from the storage device to an analytics system associated with the data user;
determining a consumption pattern of the served copy on the analytics system; and
controlling an access to the copy of the dataset on the analytics system based on the consumption pattern.
